(19) United States
(12) Patent Application Publication
(10) Pub. No.: US 2018/0372141 A1
(43) Pub. Date: Dec. 27, 2018

(54) Stripped Hole Repair Device

(71) Applicant: Andrew King, Crested Butte, CO (US)

(72) Inventor: Andrew King, Crested Butte, CO (US)

(21) Appl. No.: 15/986,315

(22) Filed: May 22, 2018

Related U.S. Application Data
(60) Provisional application No. 62/509,602, filed on May 22, 2017.

(51) Int. Cl. F16B 13/12; F16B 13/00

(52) U.S. Cl. CPC F16B 13/126; B27G 1/00; F16B 13/002; F16B 13/128

(57) ABSTRACT

Current stripped hole repair devices operate by expanding to exert pressure against the inside of a hole into which the device is placed, and are by design suitable only for repairing a stripped or damaged hole in alignment with the original hole. Likewise, various methods exist that do not result in a smooth surface into which a new hole can be drilled. In most cases, these methods are non-permanent, temporary, non-weight-bearing devices that inadequately address the problem. The solution provided comprises a solid plastic insert with segments that break off at a desired length, into which a new hole may be drilled and a screw inserted. The method for installing the apparatus utilizes an adhesive that bonds to the medium into which it is installed. The disclosure describes a simplified and practical method to repair a stripped screw hole, and an apparatus that can be manufactured and made commercially available.

### CROSS-REFERENCE TO RELATED APPLICATIONS

This application claims priority under 35 U.S.C. § 119(e) to U.S. Provisional Patent Application Ser. No. 62/509,602 filed May 22, 2017, which is incorporated herein in its entirety by reference.

### FIELD OF THE INVENTION

This disclosure relates to hole repair devices, and more specifically, this disclosure relates to an apparatus for repairing a stripped or damaged screw hole in common building and construction materials.

### BACKGROUND OF THE INVENTION

Numerous situations may lead to the problem of a stripped screw hole in such common building elements as doors, doorframes, cabinets, masonry and other locations. For example, a screw or fastener may have been over-tightened, causing the threads to strip or damage the hole into which it is fastened. Likewise, a screw or fastener may need to be repositioned for various reasons; for example, settling or shifting of a structure often requires relocating a hinge or strike plate on a door.

Some homemade repairs and carpentry methods exist to address the problems associated with a stripped screw hole. For example, a common repair method might be to plug the stripped hole with toothpicks, matchsticks, or golf tees and glue, and to then insert the screw or fastener. This method is limited to crude repairs and provides an inconsistent and temporary effect, does not result in a smooth surface into which a new hole may be drilled, and may not considered to be a structural or weight-bearing method of repair.

Other repair methods involve the use of a drywall-type wall anchor; such anchors typically have a centrally hollow portion to accept placement of a screw. This type of anchor is designed to place expansion pressure against the inside of the hole into which it is placed once a screw is inserted. Inherently, due to the centrally hollow portion of the anchor, this method may only accommodate a screw inserted in the same centered alignment as the hole being repaired; a user would not be able to adjust hole placement or slightly offset the original location. Importantly, drywall-type anchors, by design, may not function properly in wood, plywood, or medium-density fiberboard building materials and are not designed for use in structural or weight-bearing applications.

U.S. Pat. No. 9,587,662, which is incorporated herein in its entirety by reference, describes a hole repair device that has a plurality of segments that allow a user to break off a desired length of material in a stripped hole. The device has an outer diameter that tapers from its proximal end to its distal end. A central hollow cavity is provided to accept a screw into the center of the inserted device. Intermittent raised features are provided circumferentially on the exterior surface that may serve to create friction between the device and interior diameter of a hole being repaired.

However, this design has several deficiencies. The tapered shape of the devices creates a limited point of contact between an outer surface of the device and the internal surface of the parent material. This contact is limited to the uppermost portion of the stripped hole, and the device makes no contact with the lower portion of the damaged hole. As a result, the device has an inherently weak connection with the parent material and is readily dislodged from the parent material. Next, a central hollow cavity in the device itself limits screws and bolts to a single position within the device and within the stripped hole of the parent material. Therefore, this design is inflexible and does not allow for repositioned or offset holes in the device to receive screws and bolts. In addition, the raised features that secure the device to the stripped hole are pitched like threads and can cause unwanted dislodgement of the device from the hole. For example, while extracting a screw or bolt from the device, the applied forces can reverse the device out of the hole, resulting in a failure of the device. In other words, the frictional forces applied by the threads of an inserted screw to the inner hollow wall of the apparatus may exceed that of the frictional forces applied by the plastic raised features on the inner wall of a damaged screw hole into which the device is inserted.

Another repair method involves the use of a drill and bit to bore out or enlarge the stripped hole to a larger diameter and insert a wooden dowel into this new hole, thus providing a repaired surface into which the screw or fastener may now be inserted. Wooden dowels are typically found in long sections, and this repair method requires that the user have additional tools and supplies, along with the skills needed to properly cut the wooden dowel to exact size according to the depth required, and adhere it in place. The consistently smooth outer diameter of a wooden dowel inserted into the smooth bore of a parent material provides limited, or potentially no surface for adhesion of a glue or adhesive to the inner surface of the bore. Additionally, wooden dowels are commonly made of poor quality material and may therefore be subject to the same forces and stresses that caused the problem in the first place.

There is therefore a need for a stripped hole repair apparatus that provides the user a repair solution and also addresses the above problems.

### SUMMARY OF THE INVENTION

It is therefore an aspect of embodiments of the present invention to provide a stripped hole repair apparatus and method, whereby an insert is affixed in a medium or parent material to retain a fastener, such as a screw, in place. This insert can provide a smooth surface, flush with a hole within the parent material being repaired. The insert can also provide an option to locate a newly drilled hole at any location in relation to or offset from the original. In addition, the insert can have greater holding strength than the parent material being repaired such that it allows for use in a structural or weight-bearing application, and the insert can be manufactured and made commercially available as a repair kit using simple and commonly available tools.

One aspect of embodiments of the present invention is to provide an insert that has a substantially constant outer diameter, dimension, or shape extending from a distal end to a proximal end, such as that of a cylinder, to provide a flush connection with a cylindrical hole within a parent material. Thus, after an adhesive is placed in the hole or on the insert and the insert is placed in the hole, the parent materials supports the portion of the insert within the hole from the distal end to the outer surface of the parent material. The resulting effect of this arrangement is that the entire exterior surface of the device maintains contact with the entire interior surface of the hole into which it is inserted.

One aspect of embodiments of the present invention is to provide an insert with a solid body to drill a hole within to subsequently receive a screw or bolt. The solid portion of the body can extend from the proximal end of the insert to the distal end of the insert or a portion thereof. With a solid body, a user can drill a pilot hole and/or a subsequent threaded hole to receive a screw or bolt where the hole is offset from an axis of the insert or an axis of the stripped hole to provide flexibility to the user in a variety of applications of the insert. Similarly, the hole within the insert could form an angle with the axis of the insert or the stripped hole.

One aspect of embodiments of the present invention is to provide a secure bond or connection between the insert and the parent material that can resist rotational forces produced by a screw or bolt within the insert. The insert can have a substantially constant outer diameter that is supported entirely by a matching inner diameter of the stripped hole within the parent material. Score lines on the insert can increase the surface area of the outer surface of the insert, and the scores retain an adhesive, which may expand into the parent material once inserted. Effectively, a permanent bond is created between the insert and parent material, and no frictional force is present; there is no detrimental effect created, even through multiple insertions and extractions of a screw into the insert.

One aspect of embodiments of the present invention is to provide an insert made of one or more materials. Such an insert as described herein can be comprised solidly of a plastic material having such properties as minimal elongation; a sufficient tensile and flexural strength; and proper adhesion between the surface of the insert and the parent material into which it is inserted such that the material may be drilled into, that it may sufficiently retain the threads of an inserted screw, that it may be capable of shearing or breaking away at a defined break-point or circumferential score, and that it may adhere to common building materials such as solid wood, plywood, medium-density fiberboard, and masonry materials such as brick, mortar and concrete.

One aspect of embodiments of the present invention is to provide an insert that can be broken at a score to provide a desired length of material within a stripped hole. The insert is segmented in a way that allows the user, by way of breaking, shearing, cutting, or otherwise mechanically decreasing the length, to select the appropriate size required for a specific application.

One aspect of embodiments of the present invention is to provide an insert with multiple outer diameters. In some embodiments, the diameters of the insert may be defined by a step-down from a larger diameter to a smaller diameter. In these embodiments, the insert may be intended for repair of a pre-determined or defined hole depth, rather than one that may be used over a range of depths, as previously noted.

One aspect of embodiments of the present invention is to provide an insert with a solid material, thereby allowing for the device to be drilled into at any location on, within, or through the body of the insert, and permanently affixed in place through the methods described herein.

One particular embodiment of the present invention is an insert for repairing a hole, comprising a body extending between a first end and a second end, wherein the body is a continuous material between the first end and the second end; a plurality of scores on an outer surface of the body; a plurality of segments defined by the first end, the second end, and the plurality of scores; wherein each segment of the plurality of segments has the same outer diameter, and at least one segment is configured to be removed from the body by breaking an adjacent score with a predetermined shear force.

In some embodiments, the plurality of scores are spaced along a longitudinal axis of the body such that each segment of the plurality of segments have the same length along the longitudinal axis. In various embodiments, each score extends about an entire circumference of the outer surface of the body. In some embodiments, each score of the plurality of scores is configured to be broken by a predetermined shear force. In various embodiments, the body is made from a thermoplastic polymer. In some embodiments, the body has a cylindrical shape.

Another particular embodiment of the present invention is an insert for repairing a hole, comprising a body extending between a first end and a second end, wherein the body is a continuous material between the first end and the second end; a plurality of scores on an outer surface of the body; a plurality of segments defined by the first end, the second end, and the plurality of scores; wherein the segment adjacent the first end of the body has a smaller outer diameter than the remaining segments, and the remaining segments have the same outer diameter.

In various embodiments, the plurality of scores are spaced along a longitudinal axis of the body such that the segment adjacent the first end has a different length along the longitudinal axis than the remaining segments, wherein the remaining segments have the same length along the longitudinal axis. In some embodiments, the segment adjacent the first end is longer along the longitudinal axis than each remaining segment individually, and the segment adjacent the first end is shorter along the longitudinal axis than the remaining segments collectively. In various embodiments, each score extends about an entire circumference of the outer surface of the body. In some embodiments, each score between the remaining segments is configured to be broken by a predetermined shear force, and the score between the first segment and the remaining segments is configured to be broken by a reduced shear force. In various embodiments, the body is made from a thermoplastic polymer. In some embodiments, the first segment has a cylindrical shape.

Yet another particular embodiment of the present invention is a method for repairing a hole, comprising providing an insert having a body with a plurality of circumferential scores that define a plurality of segments; providing an adhesive on an outer surface of the body of the insert such that the adhesive contacts at least one circumferential score; extending the insert into a hole of a parent material such that the adhesive contacts an inner surface of the hole; breaking at least one circumferential score to leave a remaining portion of the body of the insert within the hole; and drilling a hole within the remaining portion of the body, wherein the hole is configured to receive a fastener.

In some embodiments, the hole has an axis that is offset from a longitudinal axis of the body, and the axis is parallel with the longitudinal axis. In various embodiments, the hole has an axis that forms a non-parallel angle with a longitudinal axis of the body. In some embodiments, the plurality of circumferential scores are spaced along a longitudinal axis of the body such that the segment adjacent the first end has a different length along the longitudinal axis than the remaining segments, wherein the remaining segments have the same length along the longitudinal axis. In various embodiments, the plurality of circumferential scores are spaced along a longitudinal axis of the body such that each segment of the plurality of segments have the same length along the longitudinal axis. In some embodiments, the method further comprises drilling the hole of the parent material prior to providing the adhesive on the outer surface of the body of the insert. In various embodiments, the hole has a predetermined depth, and a length of the remaining portion of the body is the same as the predetermined depth.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements or components. Additional aspects of the present invention will become more readily apparent from the Detailed Description, particularly when taken together with the drawings.

The above-described embodiments, objectives, and configurations are neither complete nor exhaustive. As will be appreciated, other embodiments of the invention are possible using, alone or in combination, one or more of the features set forth above or described in detail below.

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more,” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

### BRIEF DESCRIPTION OF THE DRAWINGS

The accompanying drawings, which are incorporated in and constitute a part of the specification, illustrate embodiments of the invention and together with the Summary of the Invention given above and the Detailed Description of the drawings given below, serve to explain the principles of these embodiments. In certain instances, details that are not necessary for an understanding of the invention or that render other details difficult to perceive may have been omitted. It should be understood, of course, that the invention is not necessarily limited to the particular embodiments illustrated herein. Additionally, it should be understood that the drawings are not necessarily to scale.

FIG. 1A is a perspective view of an insert in accordance with one embodiment of the present invention;

FIG. 1B is a side elevation view of the insert in FIG. 1A in accordance with one embodiment of the present invention;

FIG. 2 is a perspective view of another insert in accordance with one embodiment of the present invention;

FIG. 3 is a side elevation view of yet another insert in accordance with one embodiment of the present invention;

FIGS. 4A-4D show various steps of a method for using an insert to repair a hole in accordance with one embodiment of the present invention; and

FIGS. 5A-5D show various steps of a method for using another insert to repair a hole in accordance with one embodiment of the present invention.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

A list of the various components shown in the drawings and associated numbering is provided herein:

| Number | Component |
|---|---|
| 100 | Repair Insert |
| 102 | Outer Surface |
| 104 | Segment |
| 106 | Score |
| 108 | First Segment |
| 110 | Remaining Segment Length |
| 112 | First Segment Length |
| 114 | Parent Material |
| 116 | Adhesive |
| 118 | Predetermined Length |

### DETAILED DESCRIPTION

The present invention has significant benefits across a broad spectrum of endeavors. It is the Applicant's intent that this specification and the claims appended hereto be accorded a breadth in keeping with the scope and spirit of the invention being disclosed despite what might appear to be limiting language imposed by the requirements of referring to the specific examples disclosed. To acquaint persons skilled in the pertinent arts most closely related to the present invention, a preferred embodiment that illustrates the best mode now contemplated for putting the invention into practice is described herein by, and with reference to, the annexed drawings that form a part of the specification. The exemplary embodiment is described in detail without attempting to describe all of the various forms and modifications in which the invention might be embodied. As such, the embodiments described herein are illustrative, and as will become apparent to those skilled in the arts, may be modified in numerous ways within the scope and spirit of the invention.

Although the following text sets forth a detailed description of numerous different embodiments, it should be understood that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims. To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

Various embodiments of the present invention are described herein and as depicted in the drawings. It is expressly understood that although the figures depict repair devices, and methods and systems for using the same, the present invention is not limited to these embodiments.

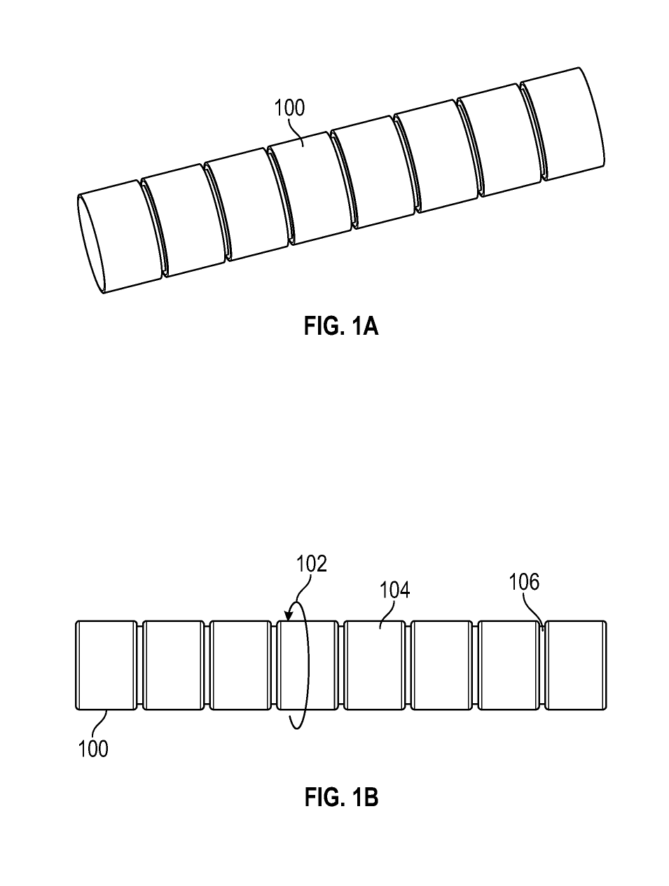

FIGS. 1A and 1B are an illustrative representation of a stripped hole repair apparatus in accordance with embodiments of the present disclosure, where a smooth plastic insert 100 is shown as a solid material having cylindrically-shaped outer surface 102. The length of the insert 100 is divided into segments 104 by one or more circumferential scores 106 into the body of the insert 100. This circumferential scoring 106 allows for the unused portion of the insert 100 break away or otherwise be snapped off following insertion, with the remaining portion retained and subsequently used to repair additional holes. These scores 106 may serve multiple purposes, for example, the scores 106 can accept and retain adhesive, allowing for greater volume of adhesive to be applied to the surface and therefore be retained inside the hole into which the device is inserted. The scores 106 can also serve a reference to the user indicating depth at which the device is to be inserted. In addition, the scores 106 can serve as a breaking-point or place at which the device is sheared off mechanically either by a user's hand or mechanical device such as a hammer.

The preferred embodiment of the invention is comprised of a thermoplastic polymer Acrylonitrile Butadiene Styrene (ABS). Other embodiments may be contemplated which are comprised of alternate types of materials and having such desirable properties as minimal elongation; a sufficient tensile and flexural strength; and proper adhesion between the surface of the device and the medium into which it is inserted. During the manufacturing process, a solid ABS rod is turned on a Swiss-type machine lathe to circumferentially cut or score a groove into, and effectively segment the body of, the described apparatus. Additionally, other manufacturing processes may be contemplated, such as Computer Numerical Control (CNC), laser machining, or injection molding. The adhesive indicated herein is a gel-type ethyl cyanoacrylate; however, other adhesives may be used which are suitable for bonding the surface of the apparatus to the medium into which it is inserted.

The embodiment of the apparatus as shown in FIGS. 1A and 1B illustrate the apparatus as comprised of a solid material. This can be advantageous in many repair situations; for example, when it is necessary or desirable to change the position of the newly drilled hole, such that it is offset or otherwise not centrally aligned with the position of the original damaged hole.

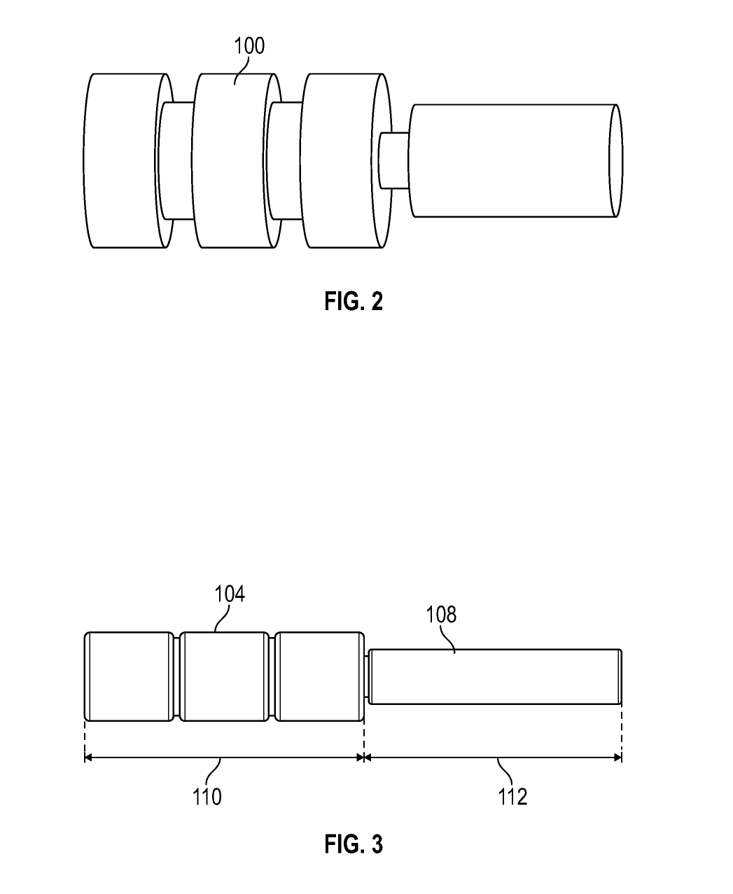

Now referring to FIGS. 2 and 3, alternative embodiments of the insert 100 are provided. In these embodiments, the first segment 108 of the insert 100 has a shape and size that is distinct from the other segments 104 of the insert 100. The first segments 108 in these embodiments are longer along a longitudinal axis of the insert 100 and is smaller in diameter compared to the other segments 104. The remaining segments 104 can be sized to fit within a hole having a depth equal or substantially equal to a length of the remaining segments 104. After the remaining segments 104 are embedded within a hole in a parent material, a user can break the score between the first segment 108 and the remaining segments 104. The smaller diameter connection between the first segment 108 and the remaining segments 104 concentrates shearing forces to provide an easier breaking. In addition, the longer length of the first segment 108 provide increased leverage to break the score between the first segment 108 and the remaining segments 104. Thus, a user could break this score by hand or by tool. While the first segment 108 is depicted as having a longer length and a smaller outer diameter, it will be appreciated that the first segment 108 could have a shorter length, a larger outer diameter, or combinations thereof compared to the other segments 104. Further still, it will be appreciated that an insert 100 may have two or more first segments 108 or even segments that all have varying lengths and diameters.

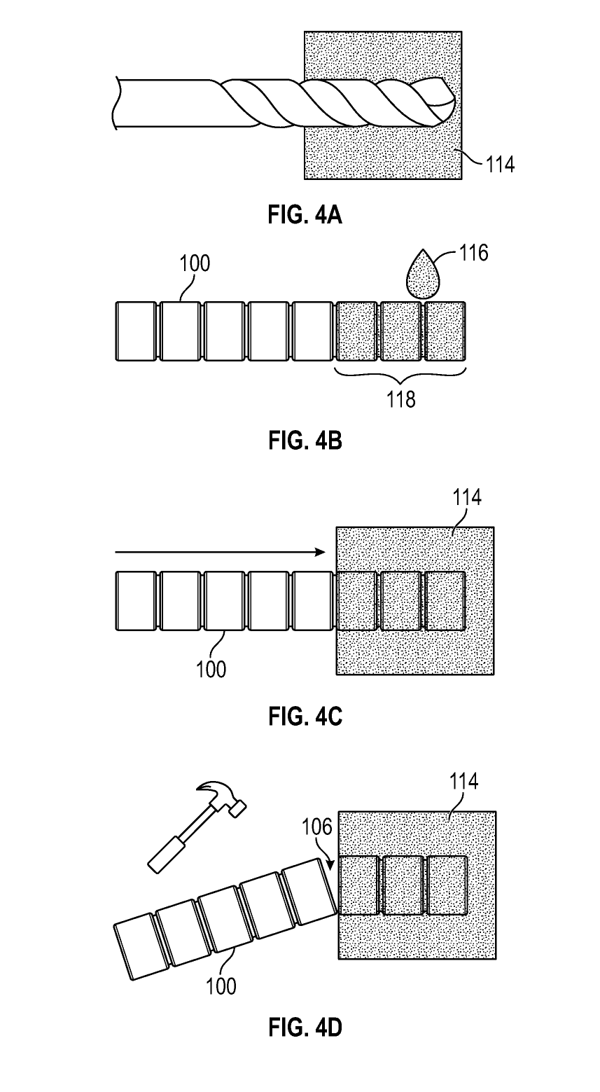

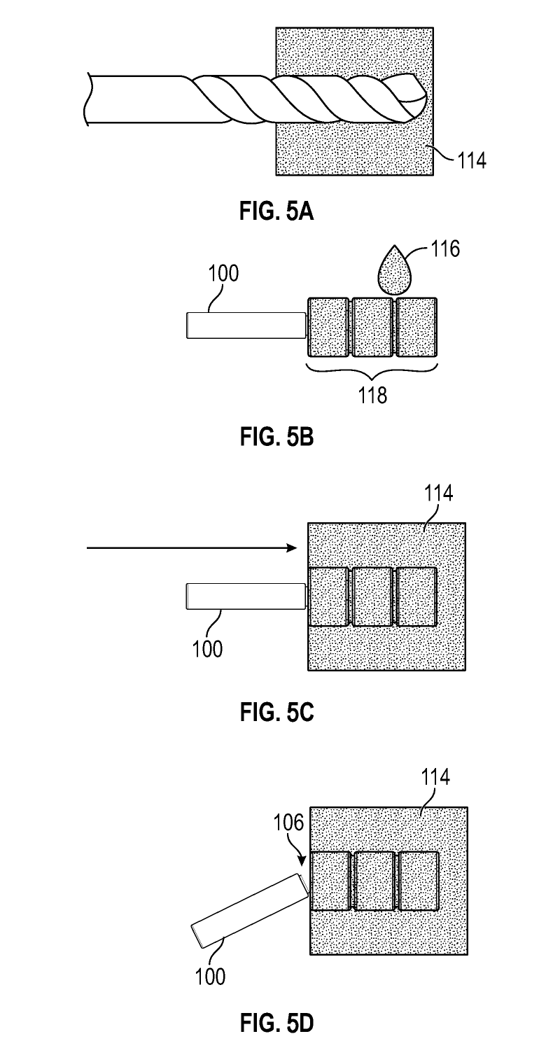

FIGS. 4A-4D depict a method of using an insert 100 to repair a stripped hole in a parent material 114. First, in FIG. 4A, the damaged hole in the parent material 114 is drilled out with a bit that corresponds to the outer diameter of the insert 100. Next, in FIG. 4B, an adhesive 116 is applied to a predetermined length 118 of the insert 100, which can correspond to the depth of the hole in the parent material 114. Then, in FIG. 4C, the insert 100 is driven into the hole in the parent material 114 to allow the adhesive 116 to secure the insert 100 within the hole. Lastly, in FIG. 4D, once the adhesive 116 has set, a force is applied to the insert 100 to shear a score and leave a portion of the insert 100 within the parent material 114. Then, a hole can be drilled into the portion of the insert 100 within the hole to receive a screw or bolt. A similar method is provided in FIGS. 5A-5D where a specialized first segment of an insert 100 is positioned outside a hole of a parent material, and the first segment can be broken by hand or by tool.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An insert for repairing a hole, comprising:
a body extending between a first end and a second end, wherein the body is a continuous material between the first end and the second end;
a plurality of scores on an outer surface of the body;
a plurality of segments defined by the first end, the second end, and the plurality of scores, wherein each segment of the plurality of segments has the same outer diameter, and at least one segment is configured to be removed from the body by breaking an adjacent score with a predetermined shear force.

2. The insert of claim 1, wherein the plurality of scores are spaced along a longitudinal axis of the body such that each segment of the plurality of segments have the same length along the longitudinal axis.

3. The insert of claim 1, wherein each score extends about an entire circumference of the outer surface of the body.

4. The insert of claim 1, wherein each score of the plurality of scores is configured to be broken by a predetermined shear force.

5. The insert of claim 1, wherein the body is made from a thermoplastic polymer.

6. The insert of claim 1, wherein the body has a cylindrical shape.

7. An insert for repairing a hole, comprising:
a body extending between a first end and a second end, wherein the body is a continuous material between the first end and the second end;
a plurality of scores on an outer surface of the body;
a plurality of segments defined by the first end, the second end, and the plurality of scores, wherein the segment adjacent the first end of the body has a smaller outer diameter than the remaining segments, and the remaining segments have the same outer diameter.

8. The insert of claim 7, wherein the plurality of scores are spaced along a longitudinal axis of the body such that the segment adjacent the first end has a different length along the longitudinal axis than the remaining segments, wherein the remaining segments have the same length along the longitudinal axis.

9. The insert of claim 8, wherein the segment adjacent the first end is longer along the longitudinal axis than each remaining segment individually, and the segment adjacent the first end is shorter along the longitudinal axis than the remaining segments collectively.

10. The insert of claim 7, wherein each score extends about an entire circumference of the outer surface of the body.

11. The insert of claim 7, wherein each score between the remaining segments is configured to be broken by a predetermined shear force, and the score between the first segment and the remaining segments is configured to be broken by a reduced shear force.

12. The insert of claim 7, wherein the body is made from a thermoplastic polymer.

13. The insert of claim 7, wherein the first segment has a cylindrical shape.

14. A method for repairing a hole, comprising:
providing an insert having a body with a plurality of circumferential scores that define a plurality of segments;
providing an adhesive on an outer surface of the body of the insert such that the adhesive contacts at least one circumferential score;
extending the insert into a hole of a parent material such that the adhesive contacts an inner surface of the hole;
breaking at least one circumferential score to leave a remaining portion of the body of the insert within the hole; and
drilling a hole within the remaining portion of the body, wherein the hole is configured to receive a fastener.

15. The method of claim 14, wherein the hole has an axis that is offset from a longitudinal axis of the body, and the axis is parallel with the longitudinal axis.

16. The method of claim 14, wherein the hole has an axis that forms a non-parallel angle with a longitudinal axis of the body.

17. The method of claim 14, wherein the plurality of circumferential scores are spaced along a longitudinal axis of the body such that the segment adjacent the first end has a different length along the longitudinal axis than the remaining segments, wherein the remaining segments have the same length along the longitudinal axis.

18. The method of claim 17, wherein the plurality of circumferential scores are spaced along a longitudinal axis of the body such that each segment of the plurality of segments have the same length along the longitudinal axis.

19. The method of claim 17, further comprising:
drilling the hole of the parent material prior to providing the adhesive on the outer surface of the body of the insert.

20. The method of claim 17, wherein the hole has a predetermined depth, and a length of the remaining portion of the body is the same as the predetermined depth.
